(19) United States
(12) Patent Application Publication
(10) Pub. No.: US 2022/0222507 A1
(43) Pub. Date: Jul. 14, 2022

(54) QUANTUM NEURAL NETWORK TRAINING METHOD AND APPARATUS, ELECTRONIC DEVICE AND MEDIUM

(71) Applicant: BEIJING BAIDU NETCOM SCIENCE TECHNOLOGY CO., LTD., BEIJING (CN)

(72) Inventors: Xin WANG, BEIJING (CN); Sizhuo YU, BEIJING (CN); Zhixin SONG, BEIJING (CN); Xuanqiang ZHAO, BEIJING (CN)

(21) Appl. No.: 17/712,640

(22) Filed: Apr. 4, 2022

(30) Foreign Application Priority Data
Apr. 21, 2021 (CN) 202110432127.0

(51) Int. Cl. G06N 3/04; G06N 10/80; G06N 3/08

(52) U.S. Cl. CPC G06N 3/0454; G06N 3/08; G06N 10/80

(57) ABSTRACT

A method is provided, including: initializing a first quantum neural network to be trained and at least two second quantum neural networks to be trained, and obtaining a quantum state training set; identifying one or more qubit pairs in an entangled state shared by the two parties; for each of a plurality of quantum state combinations: inputting quantum states of the quantum state combination into the respectively corresponding first quantum neural network, and measuring qubits output by the first quantum neutral network and not input into each of the at least two second quantum neural networks of each party so as to obtain a corresponding quantum state; selectively running a second quantum neural network respectively according to a measuring result so as to obtain quantum state output by the two parties, to compute a loss function; and adjusting a parameter value to make the loss function reach a minimum value.

### CROSS REFERENCE TO RELATED APPLICATIONS

This application claims priority to Chinese Patent Application No. 202110432127.0, filed on Apr. 21, 2021, the contents of which are hereby incorporated by reference in their entirety for all purposes.

### TECHNICAL FIELD

The present disclosure relates to the field of quantum computing, particularly relates to the technical field of quantum information transmission, in particular to a quantum neural network training method and apparatus, an electronic device, a computer readable storage medium and a computer program product.

### BACKGROUND

The human is in a new round of high-speed rising wave of quantum science and technology. More and more quantum science and technology constantly emerges, a technology of quantum hardware is also improved year by year, quantum communication and quantum Internet are also constantly developed. The most fundamental technology is Quantum Teleportation (QT), which generally refers to implementation of quantum information transmission through quantum entanglement and classical communication. It can implement quantum information transmission at any distance by utilizing quantum entanglement. Therefore, it has the irreplaceable importance for development of quantum communication, distributed quantum computing and a quantum network.

### SUMMARY

The present disclosure provides a quantum neural network training method and apparatus, an electronic device, a computer readable storage medium and a computer program product.

According to an aspect of the present disclosure, a quantum neural network training method is provided, including: for each party of two parties performing a quantum communication: initializing a first quantum neural network to be trained and at least two second quantum neural networks to be trained, and obtaining a quantum state training set corresponding to one or more qubits to be transmitted, wherein the first quantum neural network is configured to receive qubits for quantum communication, and the at least two second quantum neural networks are configured to receive qubits that are output by the first quantum neural network; identifying one or more qubit pairs in an entangled state, wherein qubits in a qubit pair are shared by the two parties of quantum communication; for each quantum state combination of a plurality of quantum state combinations, wherein each quantum state combination comprises a quantum state from each of the two quantum state training sets, performing: inputting the quantum states of the quantum state combination and the qubits in the one or more qubit pairs in the entangled state into the corresponding first quantum neural network of each party performing the quantum communication, and measuring one or more qubits output by the respective first quantum neural networks and not input into each of the at least two second quantum neural networks of each respective party so as to obtain a corresponding quantum state for each party; for each party, selectively running a corresponding second quantum neural network according to the quantum state of the other party based on a result of the measuring, so as to obtain an obtained quantum state output by the corresponding second quantum neural network for a given party of the two parties, wherein the obtained quantum state serves as quantum information exchanged by the two parties after performing the quantum communication; and computing, for each party, an error between the obtained quantum state and the corresponding quantum state in the quantum state combination; computing a value of a loss function based on errors corresponding to all the quantum state combinations; and adjusting parameter values of the first quantum neural network and the second quantum neural networks of each party performing the quantum communication to make the loss function reach a minimum value, thereby obtaining a trained first quantum neural network and trained second quantum neural networks of each party.

According to another aspect of the present disclosure, a bidirectional quantum teleportation method is provided, including: setting one or more qubit pairs in an entangled state, wherein qubits in a qubit pair are shared by two parties of quantum communication; for each party of the two parties performing quantum communication: inputting a qubit for quantum communication into a first quantum neural network, corresponding to a given party, wherein at least two second quantum neural networks corresponding to the given party are configured to receive one or more qubits that are output by the first quantum neural network corresponding to the given party; for each party, measuring one or more qubits output by the first quantum neural network and not input into the second quantum neural network so as to obtain a corresponding quantum state for the party; for each party, selectively running the corresponding second quantum neural network according to the quantum state of the other party based on a result of the measuring, so as to obtain an obtained quantum state output by the corresponding second quantum neural network for the party, wherein the obtained quantum state serves as quantum information exchanged by the two parties after performing the quantum communication; wherein the first quantum neural networks and the second quantum neural networks of each party are obtained through the operations comprising: for each party of two parties performing a quantum communication: initializing a first quantum neural network to be trained and at least two second quantum neural networks to be trained, and obtaining a quantum state training set corresponding to one or more qubits to be transmitted, wherein the first quantum neural network is configured to receive qubits for quantum communication, and the at least two second quantum neural networks are configured to receive qubits that are output by the first quantum neural network; identifying one or more qubit pairs in an entangled state, wherein qubits in a qubit pair are shared by the two parties of quantum communication; for each quantum state combination of a plurality of quantum state combinations, wherein each quantum state combination comprises a quantum state from each of the two quantum state training sets, performing: inputting the quantum states of the quantum state combination and the qubits in the one or more qubit pairs in the entangled state into the corresponding first quantum neural network of each party performing the quantum communication, and measuring one or more qubits output by the respective first quantum neural networks and not input into each of the at least two second quantum neural networks of each respective party so as to obtain a corresponding quantum state for each party; for each party, selectively running a corresponding second quantum neural network according to the quantum state of the other party based on a result of the measuring, so as to obtain an obtained quantum state output by the corresponding second quantum neural network for a given party of the two parties, wherein the obtained quantum state serves as quantum information exchanged by the two parties after performing the quantum communication; and computing, for each party, an error between the obtained quantum state and the corresponding quantum state in the quantum state combination; computing a value of a loss function based on errors corresponding to all the quantum state combinations; and adjusting parameter values of the first quantum neural network and the second quantum neural networks of each party performing the quantum communication to make the loss function reach a minimum value, thereby obtaining a trained first quantum neural network and trained second quantum neural networks of each party.

According to another aspect of the present disclosure, an electronic device is provided. The electronic equipment includes: one or more processors; and a memory storing one or more programs configured to be executed by the one or more processors, the one or more programs including instructions for causing the electronic device to perform operations comprising: for each party of two parties performing a quantum communication: initializing a first quantum neural network to be trained and at least two second quantum neural networks to be trained, and obtaining a quantum state training set corresponding to one or more qubits to be transmitted, wherein the first quantum neural network is configured to receive qubits for quantum communication, and the at least two second quantum neural networks are configured to receive qubits that are output by the first quantum neural network; identifying one or more qubit pairs in an entangled state, wherein qubits in a qubit pair are shared by the two parties of quantum communication; for each quantum state combination of a plurality of quantum state combinations, wherein each quantum state combination comprises a quantum state from each of the two quantum state training sets, performing: inputting the quantum states of the quantum state combination and the qubits in the one or more qubit pairs in the entangled state into the corresponding first quantum neural network of each party performing the quantum communication, and measuring one or more qubits output by the respective first quantum neural networks and not input into each of the at least two second quantum neural networks of each respective party so as to obtain a corresponding quantum state for each party; for each party, selectively running a corresponding second quantum neural network according to the quantum state of the other party based on a result of the measuring, so as to obtain an obtained quantum state output by the corresponding second quantum neural network for a given party of the two parties, wherein the obtained quantum state serves as quantum information exchanged by the two parties after performing the quantum communication; and computing, for each party, an error between the obtained quantum state and the corresponding quantum state in the quantum state combination; computing a value of a loss function based on errors corresponding to all the quantum state combinations; and adjusting parameter values of the first quantum neural network and the second quantum neural networks of each party performing the quantum communication to make the loss function reach a minimum value, thereby obtaining a trained first quantum neural network and trained second quantum neural networks of each party.

It should be understood that the content described in this part is not intended to identify key or important features of the embodiments of the present disclosure, nor is it used for limiting the scope of the present disclosure. Other features of the present disclosure will become easy to understand through the following specification.

### BRIEF DESCRIPTION OF THE DRAWINGS

The accompanying drawings show the embodiments by way of example, constitute a part of the specification, and together with text description of the specification, are used for explaining example implementation modes of the embodiments. The shown embodiments are only for illustration and do not limit the scope of the claims. In all the accompanying drawings, the same reference numerals refer to similar but not necessarily the same elements.

FIG. 1 shows a schematic diagram of an example system in which various methods described herein may be implemented according to an embodiment of the present disclosure;

FIG. 2 shows a schematic diagram of unidirectional quantum teleportation of an example embodiment;

FIG. 3 shows a schematic diagram of bidirectional quantum teleportation of an example embodiment;

FIG. 4 shows a schematic diagram of a circuit template of unidirectional quantum teleportation of an example embodiment;

FIG. 5 shows a flow diagram of a quantum neural network training method according to an embodiment of the present disclosure;

FIG. 6 shows a schematic diagram of a circuit template of bidirectional quantum teleportation according to an embodiment of the present disclosure;

FIG. 7 shows a schematic diagram of simulating changes of a loss function in a training process based on the circuit template as shown in FIG. 6.

FIG. 8 shows a schematic diagram of a circuit template for utilizing three noisy entanglement pairs to bidirectionally transmit four quantum states;

FIG. 9 shows a flow diagram of a bidirectional quantum teleportation method according to an embodiment of the present disclosure;

FIG. 10 shows a structure block diagram of a quantum neural network training apparatus according to an embodiment of the present disclosure;

FIG. 11 shows a structure block diagram of a bidirectional quantum teleportation apparatus according to an embodiment of the present disclosure; and

FIG. 12 shows a structure block diagram of an example electronic device capable of being configured to implement the embodiment of the present disclosure.

### DETAILED DESCRIPTION

The embodiments of the present disclosure, including various details of the embodiments of the present disclosure to facilitate understanding, are illustrated in combination with the accompanying drawings below, and should be merely regarded as examples. Therefore, those of ordinary skill in the art should appreciate that various changes and modifications can be made to the embodiments described here without departing from the scope of the present disclosure. Likewise, for clarity and conciseness, description of well-known functions and structures is omitted in the following description.

In the present disclosure, unless otherwise stated, terms “first”, “second” and the like are used for describing various elements and do not intend to limit a positional relationship, a time sequence relationship or an importance relationship of these elements, and such terms are only used for distinguishing one element from another element. In some examples, a first element and a second element may point to the same instance of the element, whereas in certain cases, they may also refer to different instances based on contextual description.

In the present disclosure, the terms used in description of the various examples are only for the purpose of describing the specific example, and are not intended to limit. Unless otherwise definitely indicated in the context, if the quantity of the elements is not limited specially, there may be one or more elements. In addition, the term “and/or” used in the present disclosure covers any one or all possible combination modes in the listed items.

The embodiments of the present disclosure will be described below in detail in combination with the accompanying drawings.

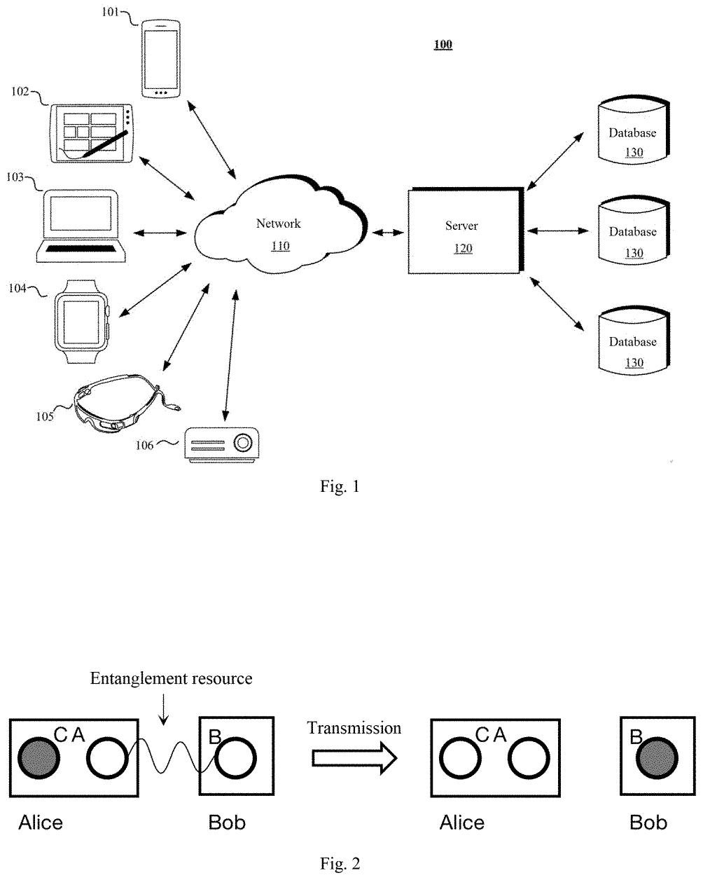

FIG. 1 shows a schematic diagram of an example system 100 in which various methods and apparatuses described herein may be implemented according to an embodiment of the present disclosure. Referring to FIG. 1, the system 100 includes one or more client devices 101, 102, 103, 104, 105 and 106, a server 120 and one or more communication networks 110 for coupling the one or more client devices to the server 120. The client devices 101, 102, 103, 104, 105 and 106 may be configured to execute one or more application programs.

In the embodiment of the present disclosure, the server 120 may run one or more services or software applications capable of executing an image filling method.

In certain embodiments, the server 120 may further provide other services or software applications which may include a non-virtual environment and a virtual environment. In certain embodiments, these services may be provided as a web-based service or a cloud service, for example, provided to users of the client devices 101, 102, 103, 104, 105 and/or 106 under a Software as a Service (SaaS) model.

In configuration shown in FIG. 1, the server 120 may include one or more components implementing functions executed by the server 120. These components may include a software component, a hardware component or combination thereof capable of being executed by one or more processors. The users operating the client devices 101, 102, 103, 104, 105 and/or 106 may interact with the server 120 by sequentially utilizing one or more client application programs, so as to utilize the services provided by these components. It should be understood that various different system configurations are possible and may be different from the system 100. Therefore, FIG. 1 is an example of the system for implementing various methods described herein, and is not intended to limit.

The client devices 101, 102, 103, 104, 105 and/or 106 may be configured to provide data, instructions and the like for training and transmitting. The client devices may provide an interface making the users of the client devices be capable of interacting with the client devices. The client devices may further output information to the users via the interface. Although FIG. 1 only depicts six client devices, those of ordinary skill in the art can understand that the present disclosure may support any quantity of client devices.

The client devices 101, 102, 103, 104, 105 and/or 106 may include various types of computer devices, for example, a portable handheld device, a general-purpose computer (such as a personal computer and a laptop computer), a workstation computer, a wearable device, a game system, a thin client, various message transceiving devices, a sensor or other sensing devices and the like. These computer devices may run various types and versions of software application programs and operating systems, for example, Microsoft Windows, Apple iOS, a UNIX-like operating system, a Linux or Linux-like operating system (such as Google Chrome OS); or include various mobile operating systems, for example, Microsoft Windows Mobile OS, iOS, Windows Phone, and Android. The portable handheld device may include a cellular phone, a smart phone, a tablet computer, a Personal Digital Assistant (PDA) and the like. The wearable device may include a head-mounted display and other devices. The game system may include various handheld game devices, Internet-supported game devices and the like. The client devices can execute various different application programs, for example, various Internet-related application programs, a communication application program (such as an Email application program), and a Short Message Service (SMS) application program, and may use various communication protocols.

The network 110 may be any type of network well known by those skilled in the art, and may use any one (including but not limited to TCP/IP, SNA, IPX and the like) in various available protocols to support data communication. Only as an example, the one or more networks 110 may be a Local Area Network (LAN), an Ethernet-based network, a token ring, a Wide Area Network (WAN), an Internet, a virtual network, a Virtual Private Network (VPN), an intranet, an extranet, a Public Switched Telephone Network (PSTN), an infrared network, a wireless network (such as Bluetooth and WIFI), and/or any combination of these and/or other networks.

The server 120 may include one or more general-purpose computers, a dedicated server computer (such as a Personal Computer (PC) server, a UNIX server, and a midrange server), a blade server, a mainframe computer, a server cluster or any other appropriate arrangements and/or combinations. The server 120 may include one or more virtual machines running a virtual operating system, or other virtualization-involved computing architectures (for example, one or more flexible pools capable of being virtualized to maintain a logical storage device of a virtual storage device of the server). In various embodiments, the server 120 may run one or more services or software applications providing functions described hereinafter.

A computing unit in the server 120 may run one or more operating systems including the above any operating system and any commercially available server operating system. The server 120 may also run any one of various additional server application programs and/or middle tier application programs, including an HTTP server, an FTP server, a CGI server, a JAVA server, a database server and the like.

In some implementation modes, the server 120 may include one or more application programs, to analyze and combine data feed and/or event updating received from the users of the client devices 101, 102, 103, 104, 105 and 106. The server 120 may further include one or more application programs, to display data feed and/or real-time events via one or more display devices of the client devices 101, 102, 103, 104, 105 and 106.

In some implementation modes, the server 120 may be a server of a distributed system, or a server combined with a blockchain. The server 120 may also be a cloud server, or an intelligent cloud computing server or an intelligent cloud host with an artificial intelligence technology. The cloud server is a host product in a cloud computing service system, so as to overcome defects of large management difficulty and weak business scalability existing in services of a traditional physical host and a Virtual Private Server (VPS).

The system 100 may further include one or more data repositories 130. In certain embodiments, these databases may be configured to store data and other information. For example, one or more of the data repositories 130 may be configured to store data such as a training set and parameters. Data repositories 130 may stay in various positions. For example, the data repositories 130 used by the server 120 may be local to the server 120, or may be away from the server 120 and may be in communication with the server 120 via network-based or dedicated connection. The data repositories 130 may be in different types. In certain embodiments, the data repositories used by the server 120 may be a database, for example, a relational database. One or more of these data repositories may store, update and retrieve data to the data repositories and from the data repositories in response to a command.

In certain embodiments, one or more of the data repositories 130 may further be used by application programs to store application program data. The data repositories 130 used by the application programs may be the different types of databases, for example, a key value repository, an object repository or a regular repository supported by a file system.

The system 100 of FIG. 1 may be configured and operated in various modes, so as to be capable of applying various methods and apparatuses described according to the present disclosure.

Currently, the realization of bidirectional quantum teleportation needs to performing two times of unidirectional quantum teleportation, whereas preparation and allocation of quantum entanglement resources are difficult. Therefore, how to utilize entanglement resources as little as possible to complete transmission of more quantum information has the very important significance for actual application of the quantum science and technology.

Taking an example of transmitting 1-qubit information, it is assumed that two parties of quantum communication are respectively: a sending party Alice and a receiving party Bob. As shown in FIG. 2, the sending and receiving parties share a qubit pair with certain entanglement before transmitting the information, which is marked as A and B (when multiple-qubit information need to be transmitted, entanglement resources also need to be increased correspondingly). In order to ensure highest fidelity of transmission, the entangled-qubit pair AB are generally prepared to be in a Bell state. The information needing to be transmitted by Alice is stored in another qubit C. In this kind of task, because the two parties of communication are usually apart, allowed physical operations are respective local operation and classical communication (LOCC) of Alice and Bob. Quantum operation usually refers to a quantum gate and quantum measurement acting on the qubits, whereas local quantum operation represents that Alice and Bob can only make the quantum operation on qubits in respective laboratories; and classical communication is usually configured to communicate, by two parties, results obtained by the quantum measurement.

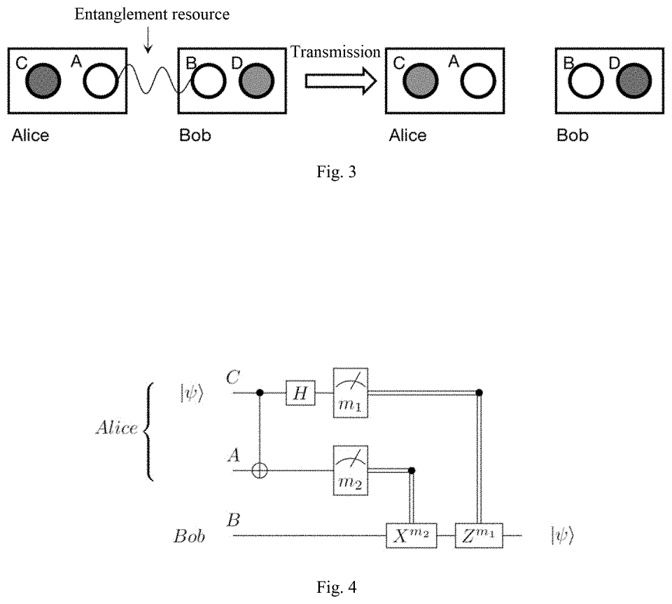

The above quantum teleportation is a unilateral information transmitting process, but there is a more efficient bidirectional transmission solution, namely, Bidirectional Quantum Teleportation (BQT). The bidirectional quantum teleportation may exchange the respective quantum information of the two parties of communication in a single transmission process, as shown in FIG. 3.

At present, the bidirectional quantum teleportation generally needs to perform two times of unidirectional quantum teleportation. Specifically, as shown in FIG. 4, Alice and Bob serving as the two parties of quantum communication hold a pre-allocated entanglement pair, namely, the qubits A and B in FIG. 3, and A and B are in the bell state Φ⁺. Meanwhile, Alice has an extra qubit C in a certain specific quantum state p. In order to transmit the quantum state of the qubit C to Bob: (1) Alice applies a controlled not gate (CNOT gate) to the qubits C and A, and then applies an Hadamard (H) gate to the qubit C; and (2) Alice measures the qubits C and A, and sends measuring results m₁m₂∈{00,01,10,11} to Bob in a classical communication mode; Bob conditionally applies X and Z rotation gates on its local qubit B according to the measuring results sent by Alice, for example, the measuring results of C and A by Alice are respectively 0 and 1, and then Bob only applies the X gate, but does not apply the Z gate. The classical communication may include modes through a mail, a phone and the like. If bidirectional quantum teleportation is to be achieved, that is, Bob also wants to send a quantum state of one local qubit to Alice, the two parties need to share two pairs of bell states and repeat operations in (1)-(3) twice, so that the quantum states respectively possessed by the two parties are sent to the other party respectively.

As for a plurality of qubits, there is no uniform solution for bidirectional teleportation of different forms of entanglement resources (different from a maximum entangled state, for example, a cluster state), and a solution proposed in an existing literature is still in a quantum circuit on a case-by-case basis. As for an application scenario of exchanging quantum states of n pairs of qubits, an existing solution at least needs to consume resources of 2n-qubits entanglement pairs.

In actual application, preparation and allocation of the quantum entanglement resources are difficult. Therefore, how to utilize the entanglement resources as little as possible to complete transmission of more quantum information has the very important significance for actual application of the quantum science and technology.

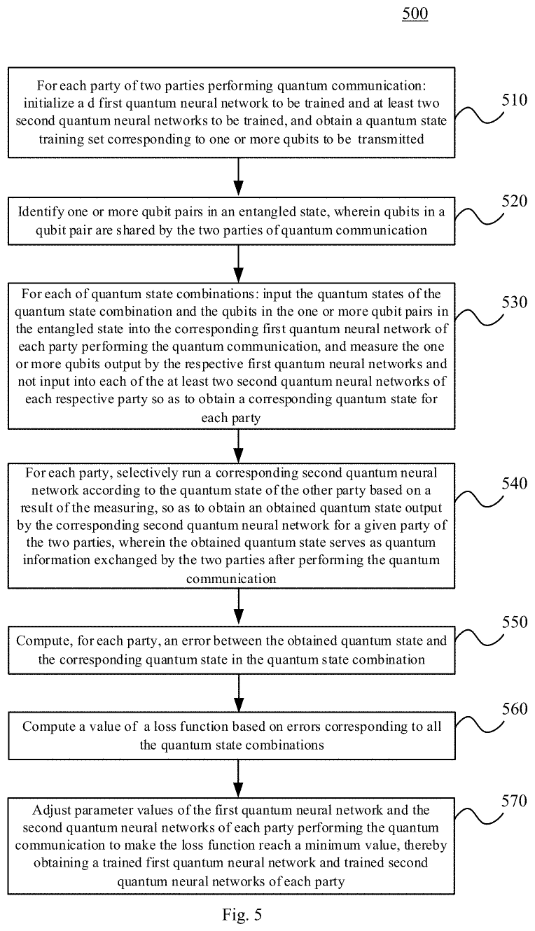

Therefore, a quantum neural network training method 500 is provided according to an embodiment of the present disclosure, as shown in FIG. 5, including: for each party of two parties performing a quantum communication: initializing a first quantum neural network to be trained and at least two second quantum neural networks to be trained, and obtaining a quantum state training set corresponding to one or more qubits to be transmitted (step 510); identifying one or more qubit pairs in an entangled state, wherein qubits in a qubit pair are shared by the two parties of quantum communication (step 520); for each quantum state combination of a plurality of quantum state combination, wherein each quantum state combination includes a quantum state from each of the two quantum state training sets, performing: inputting the quantum states of the quantum state combination and the qubits in the one or more qubit pairs in the entangled state into the corresponding first quantum neural network of each party performing the quantum communication, and measuring one or more qubits output by the respective first quantum neural networks and not input into each of the at least two second quantum neural networks of each respective party so as to obtain a corresponding quantum state for each party (step 530); for each party, selectively running a corresponding second quantum neural network according to the quantum state of the other party based on a result of the measuring, so as to obtain an obtained quantum state output by the corresponding second quantum neural network for a given party of the two parties, wherein the obtained quantum state serves as quantum information exchanged by the two parties after performing the quantum communication (step 540); and computing, for each party, an error between the obtained quantum state and the corresponding quantum state in the quantum state combination (step 550); computing a value of a loss function based on errors corresponding to all the quantum state combinations (step 560); and adjusting parameter values of the first quantum neural network and the second quantum neural networks of each party performing the quantum communication to make the loss function reach a minimum value, thereby obtaining a trained first quantum neural network and trained second quantum neural networks of each party (step 570).

According to the embodiment of the present disclosure, a plurality of quantum neural networks is respectively created for the two parties of quantum communication according to the method of the present disclosure, such that the trained quantum neural networks achieve bidirectional quantum teleportation, the consumption of entanglement resources can further be reduced, and very high scalability and adaptability are achieved.

The Quantum Neural Network (QNN) is usually composed of a plurality of single qubit rotation gates and a CNOT gate, wherein a plurality of rotation angles constitutes a vector namely, an adjustable parameter. More generally, the quantum neural network may be composed of a plurality of quantum circuits with adjustable parameters. The quantum neural network is widely applied in various quantum algorithms, for example, a VQE algorithm for solving minimum energy of a quantum system. According to the method of the present disclosure, the quantum neural networks capable of continuously optimizing the training parameters are created respectively on the locals of the two parties Alice and Bob, the two parties of communication are conditionally made to perform a local operation of parameterization again through a local measuring result and classical communication, so as to achieve bidirectional quantum teleportation.

In some examples, qubits for quantum communication include the qubits in the entangled state and the qubits to be transmitted.

In some examples, Alice and Bob firstly need to prepare a plurality of quantum neural networks with adjustable parameters locally, and a group of quantum states {ρᵢ}_{i=1 . . . n} and {σⱼ}_{j=1 . . . m} are respectively defined locally for Alice and Bob to serve as training sets. Quantum states in the training sets serve as quantum states that are to be mutually transmitted in a quantum communication process. A quantity of the qubits of the quantum states in the defined training sets adapts to a quantity of qubits that are to be transmitted in a quantum communication process to be applied, that is, if Alice actually needs to transmit a 2-bit quantum state to Bob, each quantum state ρᵢ in the group of quantum state {ρᵢ}_{i=1 . . . n} training set defined locally for Alice is a 2-bit quantum state; and it is in a similar way for Bob, which is not repeated here.

In some examples, after the quantum neural networks and the quantum state training sets are prepared, in the training process of the quantum neural networks, the two parties Alice and Bob may sequentially use the quantum states in the respective training sets as quantum states that need to be transmitted and are initialized on the qubits to be transmitted. In each training process, quantum states to be transmitted of the two parties Alice and Bob form a quantum state combination. For example, {ρᵢ}_{i=1 . . . 4} and {σⱼ}_{j=1 . . . 4} may form 16 quantum state combinations such as {ρ₁,σ₁}, {ρ₁,σ₂}, {ρ₁,σ₃}, {ρ₁,σ₄}, {ρ₂,σ₁} . . . . Other forms of quantum state combinations are also possible, which is not limited here.

In some examples, Alice and Bob make the prepared quantum neural networks act on respective quantum systems according to predefined circuit templates respectively. Alice and Bob respectively measure local qubits, and transmit the measuring results to the other party in the classical communication mode; and Alice and Bob perform local operation again according to the result of transmitted information, so as to achieve that the respective local quantum states of Alice and Bob are exchanged.

The corresponding first quantum neural network and second quantum neural networks may be prepared according to the predefined circuit templates. There may be at least two second quantum neural networks. According to some embodiments, the first quantum neural network is configured to receive the qubits for quantum communication, and each of the at least two second quantum neural networks is configured to receive the qubits that are output by the first quantum neural network and have the same quantity as the qubits to be transmitted.

According to some embodiments, for each party of two parties performing quantum communication: in response to the quantity of the one or more qubit pairs in the entangled state being smaller than the quantity of the qubits to be transmitted, each of the at least two second quantum neural networks is configured to receive qubits, corresponding to the qubit(s) in the entangled state and the one or more qubits to be transmitted, output by the first quantum neural network.

According to some embodiments, for each party of two parties performing quantum communication: in response to the quantity of the one or more qubit pairs in the entangled state being not smaller than the quantity of the qubit to be transmitted, each of the at least two second quantum neural networks is configured to receive qubits, corresponding to the qubits in the entangled state, output by the first quantum neural network.

It may be understood that when the quantity of the qubit pairs in the entangled state is not smaller than the quantity of the qubits to be transmitted, the effect of quantum information transmission is better. However, when the quantum information transmission is performed based on the circuit templates trained according to the method of the present disclosure, at least half of the qubit pairs in the entangled state may be saved compared with that in the usual unidirectional quantum teleportation.

According to some embodiments, the loss function is computed based on the following formula:

$$L = {\sum }_{i = 1}^{N} {\sum }_{j = 1}^{m} [ 2 - F ( g ( {σ}_{j} , {θ}_{k} ) , {σ}_{j} ) - F ( f ( {ρ}_{i} , {θ}_{k} ) , {ρ}_{i} ) ]$$

wherein L is the loss function, {σⱼ,ρᵢ} represents a quantum state combination composed of the quantum state σⱼ from one of the training sets and the quantum state from the other training set, g(σⱼ,θₖ) and f(ρᵢ,θₖ) respectively represent quantum states obtained when parameters of the quantum neural networks are θₖ and after σⱼ and ρᵢ are transmitted to the other party, wherein θₖ represents a group of parameter values in a k^{th} training process, each parameter value in the group of parameter values respectively corresponds to the first quantum neural network and each of the at least two second quantum neural networks of each party, F( ) represents a fidelity function, m and n and n respectively represent the quantity of the quantum states of one of the training sets and the quantity of the quantum states of the other training set.

Here, the parameters of all the quantum neural networks are uniformly marked as θ, and θ represents a vector, containing all adjustable parameters in the circuit templates. It needs to be particularly pointed out that each quantum neural network in the circuit only contains a part in the parameters θ, and the parameters contained by the different quantum neural networks are independent of each other.

According to some embodiments, the parameter values of the first quantum neural network and the second quantum neural networks of each party are adjusted through an optimization method including but not limited to a gradient descent method and the like.

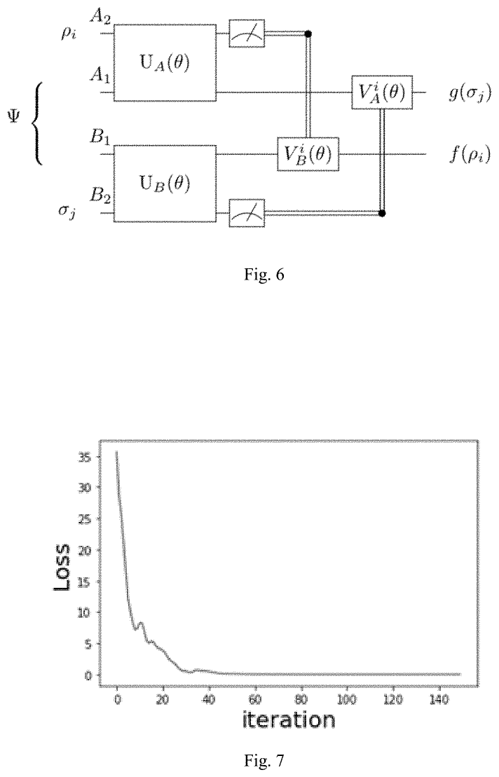

In an embodiment according to the present disclosure, the two parties Alice and Bob share an entangled-qubit pair, and the two parties Alice and Bob exchange 1-qubit information, as shown in FIG. 6. Firstly, both Alice and Bob locally define a series of single-bit quantum states that serve as training sets {ρᵢ}_{i=1 . . . n} and {σⱼ}_{j=1 . . . m}. In an example, a density matrix may be used to represent a quantum state. As shown in FIG. 6, local quantum neural networks: U_{A}(θ), V_{A}ⁱ(θ), U_{B}(θ), and V_{B}ⁱ(θ), of Alice and Bob are prepared respectively, here a subscript A is used for marking a local circuit of Alice, and a subscript B is used for marking the local quantum neural network of Bob. U_{A}(θ) and U_{B}(θ) are respectively the first quantum neural networks of Alice and Bob, V_{A}ⁱ(θ) and V_{B}ⁱ(θ) respectively represent the second quantum neural networks of Alice and Bob.

As shown in FIG. 6, V_{A}ⁱ(θ) and V_{B}ⁱ(θ) are selectively run respectively according to measuring results of B2 and A2, whereas there are only two possible measuring results of the single qubits B2 and A2: 0 or 1, therefore, V_{A}ⁱ(θ) includes V_{A}⁰(θ) and V_{A}¹(θ), and V_{B}ⁱ(θ) includes V_{B}⁰(θ) and V_{B}¹(θ), so as to selectively run each of V_{A}ⁱ(θ) and V_{B}ⁱ(θ) correspondingly according to the measuring results of B2 and A2. The parameters θ in the prepared local quantum neural networks of Alice and Bob are randomly initialized, and here, θ represents a group of parameter values corresponding to each quantum neural network. A1 and B1 are set to be the entangled-qubit pair Ψ shared by Alice and Bob. A training flow of the quantum neural networks is as follows.

(1) Initialize a number of training times to k=0, and mark the parameters as θₖ.

(2) Alice and Bob respectively select quanta ρᵢ and σⱼ from the respective training sets, and the qubits A₂ and B₂ are respectively prepared to be in ρᵢ and σⱼ.

(3) Alice and Bob respectively run the respective local quantum neural networks U_{A}(θₖ), U_{B}(θₖ).

(4) Alice and Bob respectively measure the respective local qubits A₂ and B₂, and notify the measuring results to the other party through classical communication. It is a measurement of the single qubit, and thus there are only two possible measuring results: 0 or 1.

(5) Alice and Bob respectively and selectively run their local second quantum neural networks V_{A}ⁱ(θ) and V_{B}ⁱ(θ) according to the classical communication result transmitted by the other party. For example, Alice receives the measuring result of 1 transmitted by Bob, Alice runs V_{A}¹(θ); and otherwise, Alice runs V_{A}⁰(θ). It is in a similar way for Bob.

(6) Alice and Bob respectively compute fidelity F(g)(σⱼ,θₖ),σⱼ),F(f(ρᵢ,θₖ),ρᵢ) between quantum states g(σⱼ,θₖ),f(ρᵢ,θₖ) on A₁ and B₁ and initial states σⱼ and ρᵢ prepared on B₂ and A2 in step (2), and compute L_{i,j}=2−F(g(σⱼ,θₖ),σⱼ)−F(f(ρᵢ,θₖ),ρᵢ) to serve as the loss function. When qubits on A₁ and B₁ are the same as initial states prepared on B₂ and A₂ in (2) respectively, that is, a state after transmission and a state before transmission are consistent, the fidelities are both 1, and the loss function is 0.

(7) Alice and Bob select different states to repeat (2)-(6) until all possible combinations of the quantum states in the two groups of training sets are traversed; and furthermore, the loss function of each combination is summed to serve as a total loss function L of this training. That is,

$$L = {\sum }_{i = 1}^{n} {\sum }_{j = 1}^{m} {L}_{i , j}$$

(8) Solve a gradient

$$\frac{\partial L}{\partial {θ}_{k}}$$

of the loss function L tor the parameters θₖ in the quantum neural networks, and update the parameters θₖ according to this gradient, so as to gradually find a parameter combination making the loss function minimum. For example,

$${θ}_{k + 1} = {θ}_{k} - 0.1 \times \frac{\partial L}{\partial {θ}_{k}} .$$

In addition to the above parameters θₖ adjusted through the gradient descent method, the parameters may also be updated by using other optimizers. Broadly speaking, it may be θₖ₊₁=h(θₖ).

(9) Enable k=k+1, and repeat (2)-(8) until the loss function L is not changed any more or the number of training times reach a certain preset value.

When a final loss function is minimum, it means that utilizing the above circuit templates with the parameters θ obtained through training will transmit any quantum state input respectively by Alice and Bob to the other party as accurate as possible.

After training is completed, θ obtained through training is immobilized, and in combination with the circuit templates in FIG. 6, a trained bidirectional teleportation protocol is obtained. Under given entanglement resources, the protocol may cause the two parties, through local operation and classical communication, to achieve high-precision (refer to that the fidelity of the states before and after transmission is close to 1 as far as possible) quantum information exchange as far as possible: bidirectional transmission of the local quantum state information of Alice and Bob.

As for an entanglement pair with a fixed expression form, the above training processes may be simulated to be completed on a classical computer, and the obtained protocol has the same effect for real quantum states. Certainly, it may also be completed in a real quantum system, so as to obtain an optimal result for the current entanglement resource as far as possible.

In some examples, the training process in (1)-(9) of the above embodiments may be simulated by utilizing a LOCCNet module in Paddle Quantum. The selected training set is, for example, {ρ₁,ρ₂,ρ₃,ρ₄} and {σ₁,σ₂,σ₃,σ₄}, wherein

$${ρ}_{1} = {σ}_{1} = ( \begin{matrix}1 & 0 \\ 0 & 0\end{matrix} ) , \\ {ρ}_{2} = {σ}_{2} = ( \begin{matrix}0 & 0 \\ 0 & 1\end{matrix} ) , \\ {ρ}_{3} = {σ}_{3} = ( \begin{matrix}0.5 & 0.5 \\ 0.5 & 0.5\end{matrix} ) , \\ {ρ}_{4} = {σ}_{4} = ( \begin{matrix}0.5 & - 0.5 i \\ 0.5 i & 0.5\end{matrix} ) .$$

The above selected training set is a group of single-bit linearly independent bases, and as for any quantum state p (a), it can be written as a linear combination of this group of bases. That is to say, when the loss function on this group of training set is 0, the protocol may complete bidirectional transmission of any state. Certainly, other linearly independent states may also be selected to serve as the training set, or other states are used as the training set, so as to achieve the similar effect. Specifically, a simulation result is as shown in FIG. 7, it can be seen that the loss function L reaches 0 through training, that is, a task of bidirectional quantum teleportation is completed entirely.

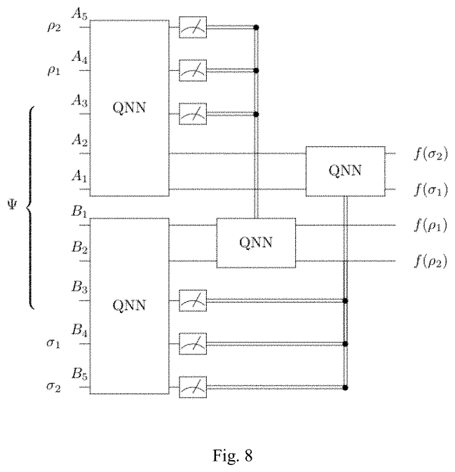

Based on the above solution of using one entanglement pair to exchange one pair of quantum states, it may be further expanded to a quantum circuit for using any noisy entanglement pair for bidirectional transmission of any quantum state by adjusting size of each circuit module in FIG. 4. Furthermore, in the case of given entanglement resources, the better transmission efficiency may be achieved, which goes far beyond an implementation range of other methods. For example, FIG. 8 shows a schematic diagram of a circuit template for utilizing three noisy entanglement pairs to bidirectionally transmit four quantum states, and the solution may implement interchange of quantum information of the two pairs of quantum states between A and B by consuming the three entanglement quantum pairs. Therefore, based on a flexible and diverse structure of the parameterized quantum circuit, the bidirectional quantum teleportation obtained by training has very high scalability and adaptability, and a proper solution may be designed for different application scenarios and quantum devices.

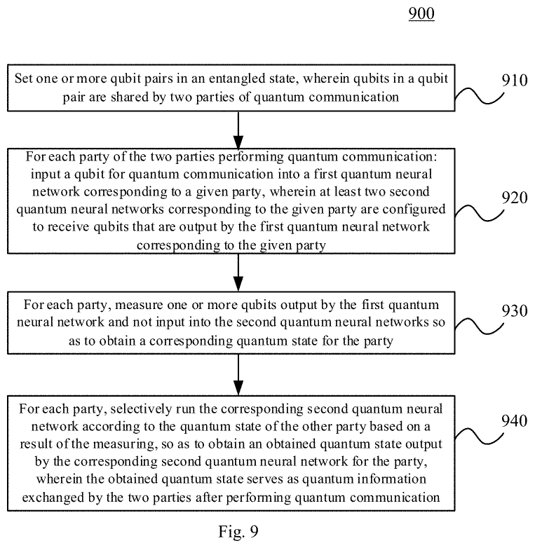

According to an embodiment of the present disclosure, a bidirectional quantum teleportation method 900 is further provided, as shown in FIG. 9, including: setting one or more qubit pairs in an entangled state, wherein qubits in a qubit pair are shared by two parties of quantum communication (step 910); for each party of the two parties performing quantum communication: inputting a qubit for quantum communication into a first quantum neural network corresponding to a given party, wherein at least two second quantum neural networks corresponding to the given party are configured to receive qubits that are output by the first quantum neural network corresponding to the given party (step 920); for each party, measuring one or more qubits output by the first quantum neural network and not input into the second quantum neural networks so as to obtain a corresponding quantum state for the party (step 930); and for each party, selectively running the corresponding second quantum neural network according to the quantum state of the other party based on a result of the measuring, so as to obtain an obtained quantum state output by the corresponding second quantum neural network for the party, wherein the obtained quantum state serves as quantum information exchanged by the two parties after performing the quantum communication (step 940). The first quantum neural networks and the second quantum neural networks of each party are obtained through the above any training method.

In some examples, the qubits for quantum communication include the qubits in the entangled state and the qubits to be transmitted.

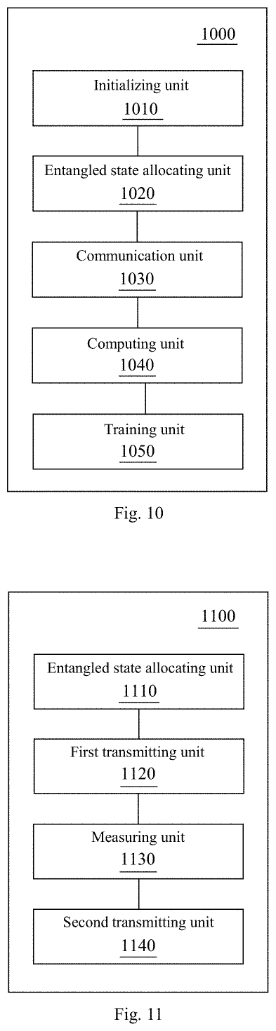

According to an embodiment of the present disclosure, a quantum neural network training apparatus 1000 is further provided, as shown in FIG. 10, including: an initializing unit 1010, configured to: as for each party in two parties of quantum communication: initialize a first quantum neural network to be trained and at least two second quantum neural networks to be trained, and obtain a quantum state training set corresponding to qubits to be transmitted, wherein the first quantum neural network is configured to receive qubits for quantum communication, and each of the at least two second quantum neural networks is configured to receive qubits that are output by the first quantum neural network and have the same quantity as the qubits to be transmitted; an entangled state allocating unit 1020, configured to: prepare one or more qubits for quantum communication to be in an entangled state; a communication unit 1030, configured to: as for each of quantum state combinations, wherein each of the quantum state combinations includes a quantum state from two groups of the training sets respectively: input quantum states in the quantum state combination and qubits in the qubit pairs in the entangled state into the corresponding first quantum neural network, and measure qubits output by each of the first quantum neural networks and not input into each of the at least two second quantum neural networks so as to obtain a corresponding quantum state; selectively run the corresponding second quantum neural networks according to a measuring result of the other party so as to obtain quantum state of qubits respectively output by the corresponding second quantum neural networks of the two parties, to serve as quantum information obtained by exchanging of the two parties after performing quantum communication; and compute an error between the quantum state obtained by each party in the two parties of quantum communication and the corresponding quantum state in the quantum state combination; a computing unit 1040, configured to: compute a loss function based on errors corresponding to all the quantum state combinations; and a training unit 1050, configured to: adjust parameter values of the first quantum neural network and the second quantum neural networks of each party in the two parties of quantum communication to make the loss function reach a minimum value, thereby obtaining trained first quantum neural network and second quantum neural networks.

Here, operations of all the above units 1010˜1050 of the quantum neural network training apparatus 1000 are similar to the operations of steps 510˜570 described previously, which is not repeated here.

According to an embodiment of the present disclosure, an electronic device, a readable storage medium and a computer program product are further provided.

According to an embodiment of the present disclosure, a bidirectional quantum teleportation apparatus 1100 is further provided, as shown in FIG. 11, including: an entangled state allocating unit 1110, configured to: prepare one or more qubits of two parties of quantum communication to be in an entangled state; a first transmitting unit 1120, configured to: as for each party in two parties of quantum communication: input qubits for quantum communication into a first quantum neural network, so as to input qubits that are output by the first quantum neural network and have the same quantity as qubits to be transmitted into a second quantum neural network; a measuring unit 1130, configured to: measure qubits output by the first quantum neural network and not input into the second quantum neural network so as to obtain a corresponding quantum state; a second transmitting unit 1140, configured to: selectively run the corresponding second quantum neural network according to a measuring result of the other party so as to obtain quantum states of qubits respectively output by the corresponding second quantum neural networks of the two parties, to serve as quantum information obtained by exchanging of the two parties after performing quantum communication, wherein the first quantum neural networks and the second quantum neural networks of the two parties of quantum communication are obtained through the above any training method.

Here, operations of all the above units 1110˜1140 of the bidirectional quantum teleportation apparatus 1100 are similar to the operations of steps 910˜940 described previously, which is not repeated here.

According to an embodiment of the present disclosure, an electronic device, a readable storage medium and a computer program product are further provided.

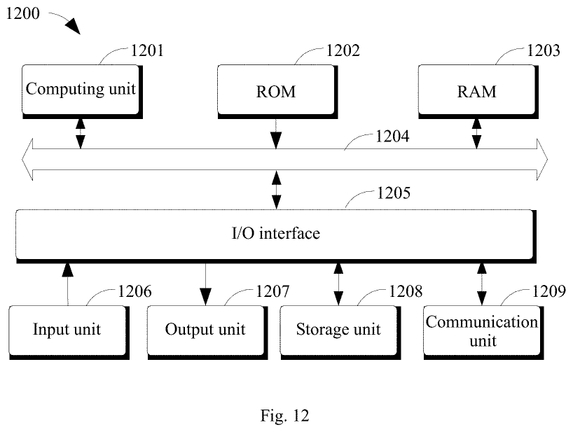

Referring to FIG. 12, a structure block diagram of an electronic device 1200 capable of serving as a server or a client of the present disclosure will be described now, which is an example of a hardware device capable of being applied to various aspects of the present disclosure. The electronic device aims to represent various forms of digital-electronic computer devices, such as a laptop computer, a desktop computer, a work table, a personal digital assistant, a server, a blade server, a mainframe computer and other proper computers. The electronic device may further represent various forms of mobile apparatuses, such as a personal digital assistant, a cellular phone, a smart phone, a wearable device, and other similar computing apparatuses. Parts shown herein, their connection and relationships, and their functions only serve as an example, and are not intended to limit implementation of the present disclosure described and/or claimed herein.

As shown in FIG. 12, the device 1200 includes a computing unit 1201, which can execute various appropriate actions and processing according to a computer program stored in a Read-Only Memory (ROM) 1202 or a computer program loaded from a storage unit 1208 to a Random Access Memory (RAM) 1203. RAM 1203 may further store various programs and data required by operations of the device 1200. The computing unit 1201, ROM 1202 and RAM 1203 are connected with each another through a bus 1204. An input/output (I/O) interface 1205 is also connected to the bus 1204.

A plurality of parts in the device 1200 are connected to the I/O interface 1205, including: an input unit 1206, an output unit 1207, a storage unit 1208 and a communication unit 1209. The input unit 1206 may be any type of devices capable of inputting information to the device 1200, and the input unit 1206 may receive input digital or character information, generates key signal input related to user setting and/or function control of the electronic device, and may include but not be limited to a mouse, a keyboard, a touch screen, a trackpad, a trackball, a joystick, a microphone and/or a remote controller. The output unit 1207 may be any type of devices capable of presenting information, and may include but not be limited to a display, a loudspeaker, a video/audio output terminal, a vibrator and/or a printer. The storage unit 1208 may include but not be limited to a magnetic disk and an optical disk. The communication unit 1209 allows the device 1200 to exchange information/data with other devices through a computer network such as an Internet and/or various telecommunication networks, and may include but not be limited to a modem, a network card, an infrared communication device, a wireless communication transceiver and/or a chipset, for example, a Bluetooth™ device, a 1302.11 device, a WiFi device, a WiMax device, a cellular communication device and/or analogues.

The computing unit 1201 may be various general and/or dedicated processing components with processing and computing abilities. Some examples of the computing unit 1201 include but not be limited to a Central Processing Unit (CPU), a Graphics Processing Unit (GPU), various dedicated artificial intelligence (AI) computing chips, various computing units running a machine learning model algorithm, a Digital Signal Processor (DSP), and any appropriate processor, controller, microcontroller and the like. The computing unit 1201 executes all the method and processing described above, for example, the methods 500 and 900. For example, in some embodiments, the methods 500 and 900 may be implemented as a computer software program which is tangibly contained in a machine readable medium, for example, the storage unit 1208. In some embodiments, part or all of the computer programs may be loaded and/or mounted on the device 1200 via ROM 1202 and/or the communication unit 1209. When the computer program is loaded to RAM 1203 and executed by the computing unit 1201, one or more steps of the methods 500 and 900 described above may be executed. Alternatively, in other embodiments, the computing unit 1201 may be configured to execute the methods 500 and 900 through any other appropriate modes (for example, by means of firmware).

Various implementation modes of the systems and technologies described above can be implemented in a digital electronic circuit system, an integrated circuit system, a Field Programmable Gate Array (FPGA), an Application Specific Integrated Circuit (ASIC), an Application Specific Standard Product (ASSP), a System On Chip (SOC), a complex programmable logic device (CPLD), computer hardware, firmware, software, and/or combinations thereof. These various implementation modes can be implemented in one or more computer programs. The one or more computer programs can be executed and/or interpreted on a programmable system including at least one programmable processor. The programmable processors may be dedicated or general programmable processors, and can receive data and instructions from a storage system, at least one input device and at least one output device, and transmit the data and instructions to the storage system, the at least one input device and the at least one output device.

Program codes for implementing the methods of the present disclosure can be compiled by adopting any combination of one or more programming languages. These program codes can be provided for processors or controllers of a general-purpose computer, a dedicated computer or other programmable data processing apparatuses, so that functions/operations specified in a flow diagram and/or a block diagram are implemented when the program codes are executed by the processors or controllers. The program codes can be executed on a machine completely or partly, can be executed on a machine partly as a stand-alone software package, and can be executed on a remote machine partly or executed on a remote machine or a server completely.

In the context of the present disclosure, the machine readable medium may be a tangible medium, and can include or store programs that are used by an instruction executing system, apparatus or device or are used in combination with the instruction executing system, apparatus or device. The machine readable medium may be a machine readable signal medium or a machine readable storage medium. The machine readable medium may include, but not be limited to electronic, magnetic, optical, electromagnetic, infrared or semi-conductor systems, apparatuses or devices, or any proper combination of the above content. The more specific examples of the machine readable storage medium can include electrical connection based on one or more wires, a portable computer disk, a hard disk, a Random Access Memory (RAM), a Read-Only Memory (ROM), an Erasable Programmable Read-Only Memory (EPROM or flash memory), an optical fiber, a portable Compact Disk Read-Only Memory (CD-ROM), an optical storage device, a magnetic storage device, or any proper combination of the above content.

In order to provide interaction with a user, the systems and technologies described herein can be implemented on a computer. The computer has: a display apparatus (for example, a Cathode Ray Tube (CRT) or a Liquid Crystal Display (LCD) monitor), configured to display information to users; and a keyboard and a pointing apparatus (for example, a mouse or a trackball) through which the users can provide input for the computer. Other kinds of apparatuses can further be configured to provide interaction with the users; for example, feedbacks provided to the users may be any form of sensing feedbacks (including visual feedback, auditory feedback, or tactile feedback); input from the users can be received in any form (including vocal input, voice input, or tactile input).

The systems and technologies described herein can be implemented in a computing system (for example, serving as a data server) including a background part, or a computing system (for example, an application server) including a middleware part, or a computing system (for example, a user computer with a graphic user interface or a network browser through which the user can interact with the implementation modes of the systems and technologies described herein) including a front-end part, or a computing system including any combination of the background part, the middleware part or the front-end part. The parts of the systems can be connected to each another through any form or medium of digital data communication (for example, a communication network). Examples of the communication network include: a Local Area Network (LAN), a Wide Area Network (WAN) and an Internet.

A computer system may include a client and a server. The client and the server generally are away from each other and usually interact with each other through the communication network. A relationship of the client and the server is generated through a computer program that runs on a corresponding computer and has a client-server relationship with the computer.

It should be understood that steps can be resorted, added or deleted by using various forms of flows shown above. For example, all the steps recorded in the present disclosure can be executed in parallel, and can also be executed in sequence or in different sequences, without limitations herein, as long as expected results of the technical solutions of the present disclosure can be implemented.

Although the embodiments or examples of the present disclosure have been described referring to the accompanying drawings, it should be understood that the above methods, systems and devices are only embodiments or examples, and the scope of the present disclosure is not limited by these embodiments or examples, and is only limited by authorized claims and the equivalent scope thereof. Various elements in the embodiments or examples can be omitted or be replaced by its equivalent elements. In addition, the steps can be executed through the sequence different from that described in the present disclosure. Further, various elements in the embodiments or examples can be combined in various modes. Importantly, as the technology evolves, many elements described here can be replaced by the equivalent elements appearing after the present disclosure.

What is claimed is:

1. A quantum neural network training method, comprising:
for each party of two parties performing a quantum communication: initializing a first quantum neural network to be trained and at least two second quantum neural networks to be trained, and obtaining a quantum state training set corresponding to one or more qubits to be transmitted, wherein the first quantum neural network is configured to receive qubits for quantum communication, and the at least two second quantum neural networks are configured to receive qubits that are output by the first quantum neural network;
identifying one or more qubit pairs in an entangled state, wherein qubits in a qubit pair are shared by the two parties of quantum communication;
for each quantum state combination of a plurality of quantum state combinations, wherein each quantum state combination comprises a quantum state from each of the two quantum state training sets, performing:
inputting the quantum states of the quantum state combination and the qubits in the one or more qubit pairs in the entangled state into the corresponding first quantum neural network of each party performing the quantum communication, and measuring one or more qubits output by the respective first quantum neural networks and not input into each of the at least two second quantum neural networks of each respective party so as to obtain a corresponding quantum state for each party;
for each party, selectively running a corresponding second quantum neural network according to the quantum state of the other party based on a result of the measuring, so as to obtain an obtained quantum state output by the corresponding second quantum neural network for a given party of the two parties, wherein the obtained quantum state serves as quantum information exchanged by the two parties after performing the quantum communication; and
computing, for each party, an error between the obtained quantum state and the corresponding quantum state in the quantum state combination;
computing a value of a loss function based on errors corresponding to all the quantum state combinations; and
adjusting parameter values of the first quantum neural network and the second quantum neural networks of each party performing the quantum communication to make the loss function reach a minimum value, thereby obtaining a trained first quantum neural network and trained second quantum neural networks of each party.

2. The method according to claim 1, wherein for each party of two parties performing quantum communication:
in response to a quantity of the one or more qubit pairs in the entangled state being smaller than a quantity of the qubits to be transmitted, each of the at least two second quantum neural networks is configured to receive qubits, corresponding to the one or more qubits in the entangled state and the one or more qubits to be transmitted, output by the first quantum neural network.

3. The method according to claim 1, wherein for each party of two parties performing quantum communication:
in response to the quantity of the one or more qubit pairs in the entangled state being not smaller than the quantity of the qubit to be transmitted, each of the at least two second quantum neural networks is configured to receive qubits, corresponding to the one or more qubits in the entangled state, output by the first quantum neural network.

4. The method according to claim 1, wherein the loss function is computed based on the following formula:
$$L = {\sum }_{i = 1}^{N} {\sum }_{j = 1}^{m} [ 2 - F ( g ( {σ}_{j} , {θ}_{k} ) , {σ}_{j} ) - F ( f ( {ρ}_{i} , {θ}_{k} ) , {ρ}_{i} ) ]$$
wherein L is the loss function, {σⱼ,ρᵢ} represents a quantum state combination composed of a quantum state σⱼ from one of the training sets and a quantum state ρᵢ from the other training set, g(σⱼ,θₖ) and f(ρᵢ,θₖ) respectively represent the quantum state obtained when parameters of the quantum neural networks are θₖ and after σⱼ and ρᵢ are transmitted to the other party, wherein θₖ represents a group of parameter values in a k^{th} training process, θₖ corresponds to the parameter values of the first quantum neural network and the at least two second quantum neural networks of each party, F( ) represents a fidelity function, and m and n respectively represent the quantity of the quantum states of one of the training sets and the quantity of the quantum states of the other training set.

5. The method according to claim 1, wherein the parameter values of the first quantum neural
network and the second quantum neural networks of each party are adjusted through an optimization method.

6. A bidirectional quantum teleportation method, comprising:
setting one or more qubit pairs in an entangled state, wherein qubits in a qubit pair are shared by two parties of quantum communication;
for each party of the two parties performing quantum communication: inputting a qubit for quantum communication into a first quantum neural network, corresponding to a given party, wherein at least two second quantum neural networks corresponding to the given party are configured to receive one or more qubits that are output by the first quantum neural network corresponding to the given party;
for each party, measuring one or more qubits output by the first quantum neural network and not input into the second quantum neural network so as to obtain a corresponding quantum state for the party;
for each party, selectively running the corresponding second quantum neural network according to the quantum state of the other party based on a result of the measuring, so as to obtain an obtained quantum state output by the corresponding second quantum neural network for the party, wherein the obtained quantum state serves as quantum information exchanged by the two parties after performing the quantum communication;
wherein the first quantum neural networks and the second quantum neural networks of each party are obtained through the operations comprising:
for each party of two parties performing a quantum communication: initializing a first quantum neural network to be trained and at least two second quantum neural networks to be trained, and obtaining a quantum state training set corresponding to one or more qubits to be transmitted, wherein the first quantum neural network is configured to receive qubits for quantum communication, and the at least two second quantum neural networks are configured to receive qubits that are output by the first quantum neural network;
identifying one or more qubit pairs in an entangled state, wherein qubits in a qubit pair are shared by the two parties of quantum communication;
for each quantum state combination of a plurality of quantum state combinations, wherein each quantum state combination comprises a quantum state from each of the two quantum state training sets, performing:
inputting the quantum states of the quantum state combination and the qubits in the one or more qubit pairs in the entangled state into the corresponding first quantum neural network of each party performing the quantum communication, and measuring one or more qubits output by the respective first quantum neural networks and not input into each of the at least two second quantum neural networks of each respective party so as to obtain a corresponding quantum state for each party;
for each party, selectively running a corresponding second quantum neural network according to the quantum state of the other party based on a result of the measuring, so as to obtain an obtained quantum state output by the corresponding second quantum neural network for a given party of the two parties, wherein the obtained quantum state serves as quantum information exchanged by the two parties after performing the quantum communication; and
computing, for each party, an error between the obtained quantum state and the corresponding quantum state in the quantum state combination;
computing a value of a loss function based on errors corresponding to all the quantum state combinations; and
adjusting parameter values of the first quantum neural network and the second quantum neural networks of each party performing the quantum communication to make the loss function reach a minimum value, thereby obtaining a trained first quantum neural network and trained second quantum neural networks of each party.

7. The method according to claim 6, wherein for each party of two parties performing quantum communication:
in response to a quantity of the one or more qubit pairs in the entangled state being smaller than a quantity of the qubits to be transmitted, each of the at least two second quantum neural networks is configured to receive qubits, corresponding to the one or more qubits in the entangled state and the one or more qubits to be transmitted, output by the first quantum neural network.

8. The method according to claim 6, wherein for each party of two parties performing quantum communication:
in response to the quantity of the one or more qubit pairs in the entangled state being not smaller than the quantity of the qubit to be transmitted, each of the at least two second quantum neural networks is configured to receive qubits, corresponding to the one or more qubits in the entangled state, output by the first quantum neural network.

9. The method according to claim 6, wherein the loss function is computed based on the following formula:
$$L = {\sum }_{i = 1}^{N} {\sum }_{j = 1}^{m} [ 2 - F ( g ( {σ}_{j} , {θ}_{k} ) , {σ}_{j} ) - F ( f ( {ρ}_{i} , {θ}_{k} ) , {ρ}_{i} ) ]$$
wherein L is the loss function, {σⱼ,ρᵢ} represents a quantum state combination composed of a quantum state σⱼ from one of the training sets and a quantum state ρᵢ from the other training set, g(σⱼ,θₖ) and f(ρᵢ,θₖ) respectively represent the quantum state obtained when parameters of the quantum neural networks are θₖ and after σⱼ and ρᵢ are transmitted to the other party, wherein θₖ represents a group of parameter values in a k^{th} training process, θₖ corresponds to the parameter values of the first quantum neural network and the at least two second quantum neural networks of each party, F( ) represents a fidelity function, and m and n respectively represent the quantity of the quantum states of one of the training sets and the quantity of the quantum states of the other training set.

10. The method according to claim 6, wherein the parameter values of the first quantum neural network and the second quantum neural networks of each party are adjusted through an optimization method.

11. A system, comprising:
one or more processors; and
one or more memories storing one or more programs configured to be executed by the one or more processors, the one or more programs including instructions for causing one or more electronic devices to perform operations comprising:
for each party of two parties performing a quantum communication: initializing a first quantum neural network to be trained and at least two second quantum neural networks to be trained, and obtaining a quantum state training set corresponding to one or more qubits to be transmitted, wherein the first quantum neural network is configured to receive qubits for quantum communication, and the at least two second quantum neural networks are configured to receive qubits that are output by the first quantum neural network;
identifying one or more qubit pairs in an entangled state, wherein qubits in a qubit pair are shared by the two parties of quantum communication;
for each quantum state combination of a plurality of quantum state combinations, wherein each quantum state combination comprises a quantum state from each of the two quantum state training sets, performing:
inputting the quantum states of the quantum state combination and the qubits in the one or more qubit pairs in the entangled state into the corresponding first quantum neural network of each party performing the quantum communication, and measuring one or more qubits output by the respective first quantum neural networks and not input into each of the at least two second quantum neural networks of each respective party so as to obtain a corresponding quantum state for each party;
for each party, selectively running a corresponding second quantum neural network according to the quantum state of the other party based on a result of the measuring, so as to obtain an obtained quantum state output by the corresponding second quantum neural network for a given party of the two parties, wherein the obtained quantum state serves as quantum information exchanged by the two parties after performing the quantum communication; and
computing, for each party, an error between the obtained quantum state and the corresponding quantum state in the quantum state combination;
computing a value of a loss function based on errors corresponding to all the quantum state combinations; and
adjusting parameter values of the first quantum neural network and the second quantum neural networks of each party performing the quantum communication to make the loss function reach a minimum value, thereby obtaining a trained first quantum neural network and trained second quantum neural networks of each party.

12. The system according to claim 11, wherein for each party of two parties performing quantum communication:
in response to a quantity of the one or more qubit pairs in the entangled state being smaller than a quantity of the qubits to be transmitted, each of the at least two second quantum neural networks is configured to receive qubits, corresponding to the one or more qubits in the entangled state and the one or more qubits to be transmitted, output by the first quantum neural network.

13. The system according to claim 11, wherein for each party of two parties performing quantum communication:
in response to the quantity of the one or more qubit pairs in the entangled state being not smaller than the quantity of the qubit to be transmitted, each of the at least two second quantum neural networks is configured to receive qubits, corresponding to the one or more qubits in the entangled state, output by the first quantum neural network.

14. The system according to claim 11, wherein the loss function is computed based on the following formula:
$$L = {\sum }_{i = 1}^{N} {\sum }_{j = 1}^{m} [ 2 - F ( g ( {σ}_{j} , {θ}_{k} ) , {σ}_{j} ) - F ( f ( {ρ}_{i} , {θ}_{k} ) , {ρ}_{i} ) ]$$
wherein L is the loss function, {σⱼ,ρᵢ} represents a quantum state combination composed of a quantum state σⱼ from one of the training sets and a quantum state ρᵢ from the other training set, g(σⱼ,θₖ) and f(ρᵢ,θₖ) respectively represent the quantum state obtained when parameters of the quantum neural networks are θₖ and after σⱼ and ρᵢ are transmitted to the other party, wherein θₖ represents a group of parameter values in a k^{th} training process, θₖ corresponds to the parameter values of the first quantum neural network and the at least two second quantum neural networks of each party, F( ) represents a fidelity function, and m and n respectively represent the quantity of the quantum states of one of the training sets and the quantity of the quantum states of the other training set.

15. The system according to claim 11, wherein the parameter values of the first quantum neural network and the second quantum neural networks of each party are adjusted through an optimization method.
